(19) United States
(12) Patent Application Publication
(10) Pub. No.: US 2024/0114875 A1
(43) Pub. Date: Apr. 11, 2024

(54) MANUFACTURING METHOD FOR ANIMAL TOILET AND ANIMAL TOILET

(71) Applicant: Unicharm Corporation, Ehime (JP)

(72) Inventors: Hiroki Yamamoto, Kanonji-Shi (JP); Shinya Kaneko, Kanonji-shi (JP); Yasuhiro Sasano, Kanonji-shi (JP); Yasuhiro Akino, Kanonji-shi (JP)

(73) Assignee: Unicharm Corporation, Ehime (JP)

(21) Appl. No.: 18/529,107

(22) Filed: Dec. 5, 2023

(30) Foreign Application Priority Data
Jun. 29, 2021 (JP) 2021-107343

(51) Int. Cl. A01K 1/01; B29C 45/00

(52) U.S. Cl. CPC A01K 1/0107; B29C 45/0053

(57) ABSTRACT

A manufacturing method of an animal litter box includes: a mold preparation process of preparing a mold for molding a resin molding product that forms at least a part of the animal litter box and has a urinary contact portion, the mold including an injection hole for injecting resin; a resin injecting process of injecting the resin from the injection hole; and a smoothing process of smoothing the resin of the urinary contact portion, the resin facing an inner opening of the injection hole, after the resin injecting process.

### BACKGROUND

### Technical Field

Present invention relates to a manufacturing method for an animal litter box and an animal litter box.

### Description of Related Art

Animal litter boxes for use by animals such as cats are conventionally known. For example, Patent Document 1 discloses an animal litter box including: an upper container that includes an opening for animals to enter and exit, and a liquid-permeable bottom surface portion that allows excreted urine to pass through; a placement container in which an absorbent sheet that absorbs the urine that has passed through the bottom surface portion is placed; and a lower container that is located below the bottom surface portion and that accommodates the placement container while supporting the upper container. In such an animal litter box, a plurality of openings are provided in a net-like or drainboard-like manner in the bottom surface portion of the upper container, and excreted urine passes through the openings of the bottom surface portion and moves to the lower container side.
[Patent Document 1] Japanese Patent Application Publication No. 2009-11181

In the case where at least a part of the animal litter box, such as the foregoing liquid-permeable bottom surface portion, is made of resin, if the surface of the part made of resin has unevenness, there is a risk that urine accumulates in the hollow parts of the surface, causing unpleasant odor and causing dirt to accumulate.

### SUMMARY

One or more embodiments of the present invention provide a manufacturing method for an animal litter box, which reduces the risk that protrusions/recesses of resin occur on the surface of the animal litter box.

An aspect of the present invention is a manufacturing method of an animal litter box, the animal litter box having a front-rear direction, a lateral direction, and a vertical direction, the animal litter box including: a urine passage portion that has a plurality of holes (i.e., urine passing holes) through which urine passes; and an absorbent-body placement portion that is disposed below the urine passage portion and in which an absorbent body that absorbs urine that has passed through the urine passage portion is placed, the manufacturing method including: a mold preparation process of preparing a mold for molding a resin molding product that forms at least a part of the animal litter box and has a urinary contact portion, the mold having an injection hole for injecting resin; a resin injecting process of injecting the resin from the injection hole; and a smoothing process of smoothing the resin of the urinary contact portion, the resin facing an inner opening of the injection hole, after the resin injecting process.

Features of one or more embodiments of the present invention other than the above will become clear by reading the description of the present specification with reference to the accompanying drawings.

According to one or more embodiments of the present invention, it is possible to reduce the odor of urine caused by urine collecting or remaining in protrusions/recesses of a resin molding product of an animal litter box.

### BRIEF DESCRIPTION OF DRAWINGS

FIG. 1 is a schematic perspective view of an animal litter box 1.

FIG. 2 is an exploded side view of the animal litter box 1.

FIG. 3 is three-side-view diagram of an upper container 10.

FIG. 4 is a diagram illustrating a cross section taken along line A-A in FIG. 3.

FIG. 5 is a three-side-view diagram of a lower container 20.

FIG. 6 is a three-side-view diagram of a tray 30.

FIG. 7A is a diagram showing a conventional process of injecting resin into a mold. FIG. 7B is a diagram showing the conventional process of separating a fixed mold and a resin molding product.

FIG. 8 is a flow chart of a manufacturing process of the upper container 10.

FIG. 9 is an enlarged view of a portion D in FIG. 3.

FIG. 10A is a diagram illustrating a mold preparation process. FIG. 10B is a diagram illustrating a mold clamping process.

FIG. 11A is a diagram illustrating a valve-rod releasing process. FIG. 11B is a diagram illustrating a resin injecting process.

FIG. 12A is a diagram illustrating a resin-injection stopping process.

FIG. 12B is a diagram illustrating a smoothing process.

FIG. 13A is a diagram illustrating a mold separating process. FIG. 13B is a diagram illustrating an upper-container demolding process.

FIG. 14A is a schematic perspective view of a bottom portion 11 when viewed from a lower surface side. FIG. 14B is a diagram illustrating a cross section taken along line X-X in FIG. 14A.

### DETAILED DESCRIPTION OF EMBODIMENTS

At least the following matters will be clear with the description of this specification and the attached drawings.

A manufacturing method of an animal litter box, the animal litter box having a front-rear direction, a lateral direction, and a vertical direction, the animal litter box including: a urine passage portion that has a plurality of holes through which urine passes; and an absorbent-body placement portion that is provided below the urine passage portion and where an absorbent body that absorbs urine that has passed through the urine passage portion is placed, at least a part of the animal litter box being a resin molding product, the resin molding product having a urinary contact portion that has a possibility of coming into contact with urine, the manufacturing method including: a mold preparation process of preparing a mold, the mold including an injection hole for injecting resin, and the mold being for molding the resin molding product; a resin injecting process of injecting the resin from the injection hole; and a smoothing process of smoothing the resin of a portion of the urinary contact portion that faces an inner opening of the injection hole, after the resin injecting process.

According to the manufacturing method for an animal litter box, in the manufacturing process of the animal litter box, it reduces the risk that protrusions/recesses of resin are formed in the urinary contact portion of the resin molding product, and this makes it easier to reduce the odor of urine caused by urine collecting or remaining in protrusions/recesses of the resin molding product.

In such a manufacturing method for an animal litter box, the resin molding product may be at least one of: the urine passage portion; the absorbent-body placement portion; a supporting portion that supports the absorbent-body placement portion; and a cover that is disposed above the urine passage portion.

According to manufacturing method animal litter box of animal litter box, it reduces the risk that protrusions/recesses of resin are formed in the urinary contact portion of at least one of the urine passage portion, the absorbent-body placement portion, the supporting portion, and the cover. This makes it easier to reduce the odor of urine caused by urine collecting or remaining in protrusions/recesses of the resin molding product.

In such a manufacturing method for an animal litter box, the manufacturing method may further comprise a demolding process of demolding the resin molding product that has been molded from the mold after the resin injecting process, and the smoothing process may be performed after the demolding process.

According to the manufacturing method for an animal litter box, it makes it easier to reliably smooth protrusions/recesses of the urinary contact portion of the resin molding product.

In such a manufacturing method for an animal litter box, the smoothing process may include removing a projection of the resin molding product that protrudes from a surface of the resin molding product.

According to such animal litter box and manufacturing method, it is possible to easily smooth the urinary contact portion of the resin molding product.

In such a manufacturing method for an animal litter box, the smoothing process may include filling a recessed portion of a surface of the resin molding product.

According to such animal litter box and manufacturing method, it is possible to easily smooth the urinary contact portion of the resin molding product.

In such a manufacturing method for an animal litter box, the manufacturing method may further comprise a demolding process of demolding the resin molding product that has been molded from the mold, and the demolding process may be performed after the smoothing process.

According to the manufacturing method for an animal litter box, the smoothing process can be performed within the mold, making it easier to simplify the manufacturing process.

In such a manufacturing method for an animal litter box, the manufacturing method may further comprise: preparing a valve rod that moves with respect to the injection hole by receiving a driving power from a drive source, the resin injecting process may include injecting the resin in a state where a tip surface of the valve rod is located closer to an outer opening than is the inner opening, and the smoothing process may include smoothing the resin by closing the inner opening with the valve rod and by aligning the tip surface with an edge of the inner opening.

According to the manufacturing method for an animal litter box, the smoothing process can be performed within the mold, making it easier to simplify the manufacturing process.

In such a manufacturing method for an animal litter box, the manufacturing method may further comprise: preparing a valve rod supported by a spring and movable with respect to the injection hole, the resin injecting process may include injecting the resin in a state where a tip surface of the valve rod protrudes from the inner opening into the mold by an inflow pressure of the resin, and the smoothing process may include closing the inner opening the valve rod by a restoring force of the spring, and smoothing the resin by aligning the tip surface with an edge of the inner opening.

According to the manufacturing method for an animal litter box, the smoothing process can be performed within the mold, making it easier to simplify the manufacturing process.

In such a manufacturing method for an animal litter box, the manufacturing method may further comprise: preparing a valve rod supported by a spring and movable with respect to the injection hole, the resin injecting process may include injecting the resin in a state where a tip surface of the valve rod is located closer to an outer opening than is the inner opening by an inflow pressure of the resin, and the smoothing process may include closing the inner opening with the valve rod by a restoring force of the spring, and smoothing the resin by aligning the tip surface with an edge of the inner opening.

According to the manufacturing method for an animal litter box, the smoothing process can be performed within the mold, making it easier to simplify the manufacturing process.

In such a manufacturing method for an animal litter box, the mold may have a protruding portion that faces the inner opening and protrudes toward the inner opening.

According to the manufacturing method for an animal litter box, in the resin injecting process, it is possible to reduce a risk of air pockets remaining in the portion that faces the injection hole.

In such a manufacturing method for an animal litter box, the resin molding product may be the urine passage portion, and the smoothing process may include smoothing the resin on an upper surface of the urine passage portion.

When an animal excretes, urine passes from above to below through the urine passage portion. Therefore, according to the manufacturing method for an animal litter box, by smoothing the unevenness on the upper surface of the urine passage portion, it is possible to reduce a risk of causing unpleasant odor due to urine accumulating in protrusions/recesses of the upper surface of urine passage portion.

In such a manufacturing method for an animal litter box, the mold may include: a fixed mold for molding at least an upper end of the urine passage portion, and a movable mold for molding at least a lower end of the urine passage portion, the fixed mold includes the injection hole, the movable mold may include an ejector pin for separating the urine passage portion from the movable mold in a demolding process of demolding the urine passage portion that has been molded from the mold after the resin injecting process, and a number of the injection hole may be smaller than a number of the ejector pin.

In the portions of the urine passage portion that come into contact with the injection holes and the ejector pins, marks such as projected/recessed portions are likely to remain due to injection of resin and separation from the mold. According to the manufacturing method for an animal litter box, the number of protrusions/recesses that have been formed on the upper surface of the urine passage portion due to the consequent evidence of resin injection can be made smaller than the number of protrusions/recesses that have been formed on the lower surface of the urine passage portion due to contact with the ejector pins. This makes it possible to reduce the risk of unpleasant odors caused by urine accumulating in the protrusions/recesses on the upper surface of the urine passage portion.

In such a manufacturing method for an animal litter box, the mold may have a fixed mold for molding at least an upper end of the urine passage portion, and a movable mold for molding at least a lower end of the urine passage portion, and the fixed mold may include: the injection hole; and an ejector pin for separating the urine passage portion from the movable mold in a demolding process of demolding the urine passage portion that has been molded from the mold after the resin injecting process.

According to the manufacturing method for an animal litter box, it is possible to reduce protrusions/recesses that have been formed on the upper surface of the urine passage portion due to the consequent evidence of resin injection. This makes it possible to reduce a risk of unpleasant odors caused by urine accumulating in the protrusions/recesses on the upper surface of the urine passage portion.

In such a manufacturing method for an animal litter box, the resin molding product may be the urine passage portion, and the smoothing process may include smoothing the resin on a lower surface of the urine passage portion.

According to the manufacturing method for an animal litter box, by reducing the protrusions/recesses on the lower surface of the urine passage portion, it is possible to reduce the risk of unpleasant odor caused by urine whose concentration has been increased because the urine passes through the holes of the urine passage portion, remains on the protrusions/recesses of the lower surface, and the water in the urine evaporates.

In such a manufacturing method for an animal litter box, the mold may include: a fixed mold for molding at least a lower end of the urine passage portion, and a movable mold for molding at least an upper end of the urine passage portion, the fixed mold may include the injection hole, the movable mold may include an ejector pin for separating the urine passage portion from the movable mold in a demolding process of demolding the urine passage portion that has been molded from the mold after the resin injecting process, and a number of the injection hole may be smaller than a number of the ejector pin.

In the portions of the urine passage portion that come into contact with the injection holes and the ejector pins, marks such as projected/recessed portions are likely to remain due to injection of resin and separation from the mold. According to the manufacturing method for an animal litter box, the number of protrusions/recesses that have been formed on the lower surface of the urine passage portion due to the consequent evidence of resin injection can be made smaller than the number of protrusions/recesses that have been formed on the upper surface of the urine passage portion due to contact with the ejector pins. This makes it possible to reduce the risk of unpleasant odor caused by urine whose concentration has been increased because the urine passes through the holes of the urine passage portion, remains on the protrusions/recesses of the lower surface, and the water in the urine evaporates.

An animal litter box having a front-rear direction, lateral direction, and vertical direction, the animal litter box including: a urine passage portion that has a plurality of holes through which urine passes; and an absorbent-body placement portion that is provided below the urine passage portion and where an absorbent body that absorbs urine that has passed through the urine passage portion is placed, at least a part of the animal litter box being a resin molding product, the resin molding product having a urinary contact portion that has a possibility of coming into contact with urine, a mold being prepared, the mold having an injection hole for injecting resin, and the mold being for molding the resin molding product, the resin being injected from the injection hole, the animal litter box being manufactured by smoothing the resin of a portion of the urinary contact portion that faces an inner opening of the injection hole, the smoothing being performed after the resin injection.

According to the animal litter box, it reduces a risk that protrusions/recesses of resin are formed in the urinary contact portion of the animal litter box, and this makes it easier to reduce the odor of urine caused by urine collecting or remaining in protrusions/recesses of the resin molding product.

In such a manufacturing method for an animal litter box, the mold may have a fixed mold for molding at least a lower end of the urine passage portion, and a movable mold for molding at least an upper end of the urine passage portion, and the fixed mold may include: the injection hole; and an ejector pin for separating the urine passage portion from the movable mold in a demolding process of demolding the urine passage portion that has been molded from the mold after the resin injecting process.

According to the manufacturing method for an animal litter box, it is possible to reduce protrusions/recesses that have been formed on the lower surface of the urine passage portion due to the consequent evidence of resin injection. This makes it possible to reduce a risk of unpleasant odor caused by urine whose concentration has been increased because the urine passes through the holes of the urine passage portion, remains on the protrusions/recesses of the lower surface, and the water in the urine evaporates.

### Embodiments

### Overall Configuration

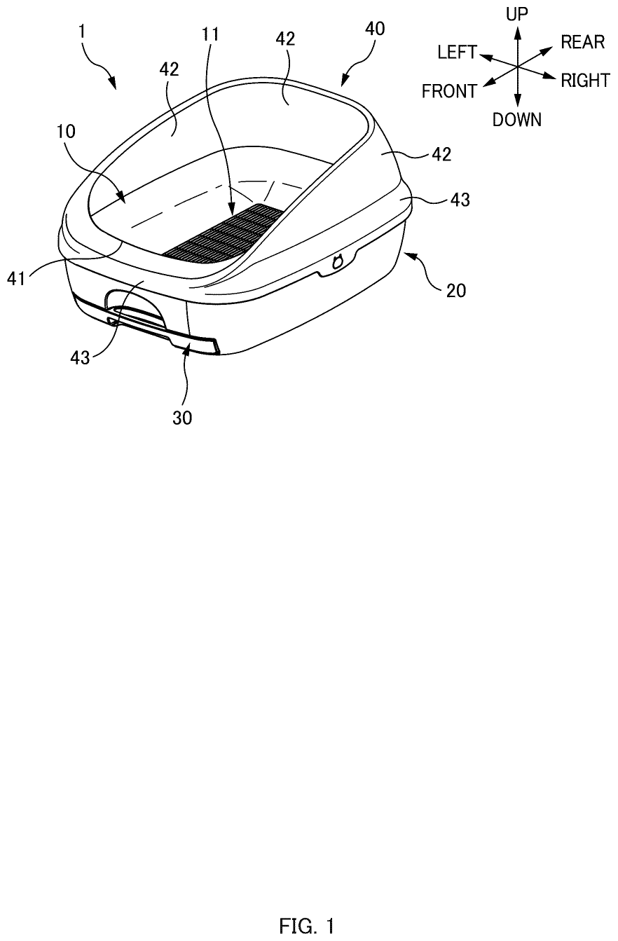

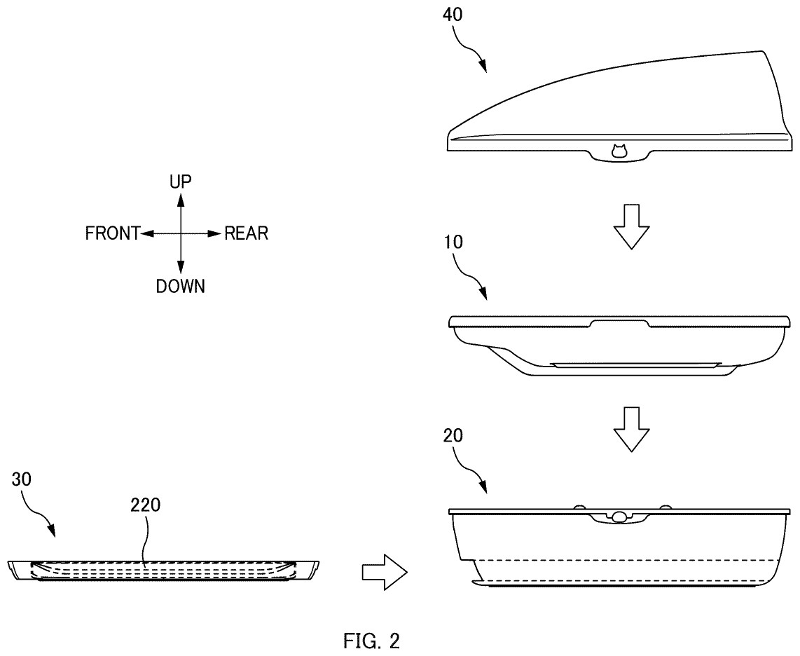

The following describes an animal litter box 1 by way of example of an animal litter box according to one or more embodiments. FIG. 1 is a schematic perspective view of an animal litter box 1. FIG. 2 is an exploded side view of the animal litter box 1. Furthermore, in the following description, a “front-rear direction”, a “lateral direction”, and a “vertical direction” are defined as three directions that are orthogonal to each other as shown in FIG. 1. The Front-rear direction is a direction that conforms to the longitudinal direction of the animal litter box 1, and the front side is the side where the animal entrance is provided. The lateral direction is a direction that conforms to a width direction of the animal litter box 1. The vertical direction is a direction that conforms to the up-down direction. Note that the parts of the animal litter box 1 have their own predetermined thicknesses, and with respect to the thickness of each of the parts, the upper side in the vertical direction is referred to as the “upper surface”, and the lower side in the vertical direction is referred to as the “lower surface”.

The animal litter box 1 has an upper container 10, a lower container 20, a tray 30, and a cover 40, and these four parts constitute the animal litter box 1 that is in the state of use shown in FIG. 1. The four parts can be freely attached to and detached to each other as shown in FIG. 2. Specifically, the lower container 20 is placed being stacked below and attached to the upper container 10. The lower container 20 accommodates the tray 30 in which an absorbent body 220 (to be described later) that absorbs excreted urine and the like can be placed. The cover 40 is attached to the upper portion of the upper container 10. Since the parts can be detached from each other in this manner, this makes cleaning easier.

Note that each of the upper container 10, the lower container 20, the tray 30, and the cover 40 is formed of polyolefin-based thermoplastic resin, such as polyethylene, polypropylene, polyethylene terephthalate and the like. However, the material constituting the parts is not limited thereto. It is sufficient that at least one part is made of resin, and for example it may be made of other resin or it may also use a part made of metal plate such as stainless steel plate or aluminum plate.

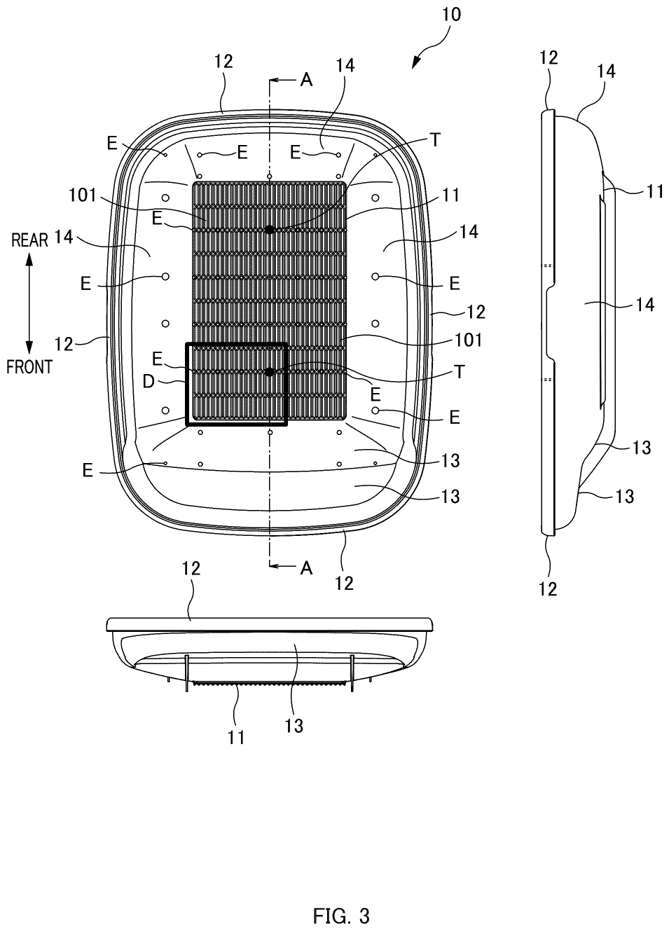

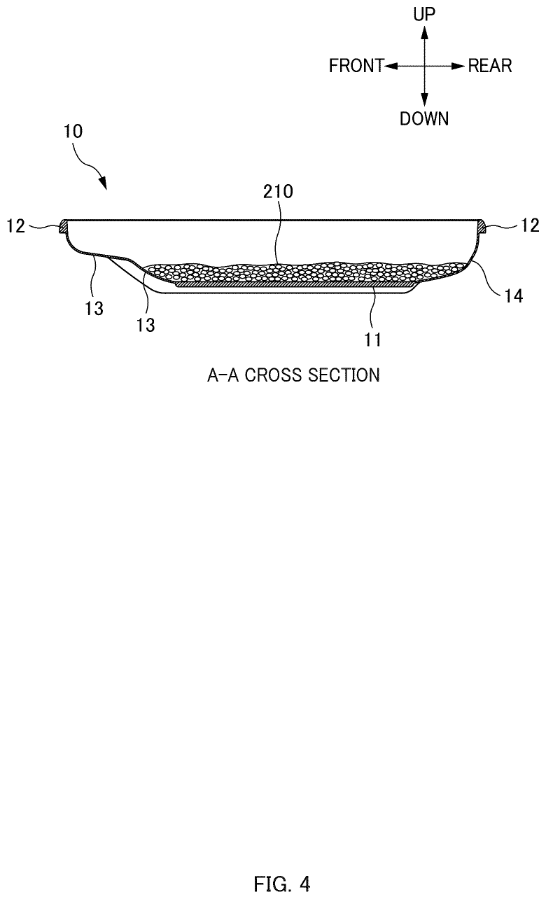

FIG. 3 is three-side-view diagram of the upper container 10. FIG. 4 is a diagram illustrating a cross section taken along line A-A in FIG. 3. The upper container 10 is a substantially box-shaped part that has an open upper side, and has a plurality of holes 101 through which urine passes. The upper container 10 is also referred to as a “urine passage portion”. Animals such as cats excrete on the upper surface side of the upper container 10 (corresponding to the inside of the box). The upper container 10 includes a bottom portion 11, an edge portion 12, a stepped portion 13, and an inclined portion 14.

The bottom portion 11 is a portion that constitutes the bottom surface of the upper container 10, and is located at the lowest position in the upper container 10 in the vertical direction (see FIG. 4). On the bottom portion 11, there is provided with a plurality of holes (also referred to as “slits”) 101 through which urine etc. excreted by an animal pass from above to below in the vertical direction. The hole 101 penetrates in the vertical direction. Excreted urine passes through the holes 101 and moves from above to below in the upper container 10.

When the animal litter box 1 is used, granules such as cat litter are placed on the upper surface of the bottom portion 11, and an animal such as a cat excretes from above on the granules. In one or more embodiments, excrement treating materials 210 are placed as granules as shown in FIG. 4. The excrement treating material 210 is a granule material having a porous structure, such as zeolite or silica gel, and exhibits effects of moisture removal and deodorizing by absorbing ammonia components upon contact with urine or the like excreted by an animal. Further, by placing the granular excrement treating material 210 in the bottom portion 11, it makes an animal more likely to recognize that the bottom portion 11 is a location where excretion is intended. Note that, in order to suppress the case where granules of the excrement treating material 210 fall downward through the holes 101 of the bottom portion 11, the holes 101 may have a shape and size that allows urine to pass through but does not allow the excrement treating material 210 to pass through. In one or more embodiments, the holes 101 are a slit elongated in the front-rear direction as shown in FIG. 3.

The edge portion 12 is a portion that constitutes the outer edge of the upper container 10 in the front-rear direction and the lateral direction. This edge portion 12 has a shape that is folded outward at the upper end of the upper container 10, and can be stacked vertically on a later-described edge portion 22 of the lower container 20. The stepped portion 13 is a portion where there is a height difference on the front side between the edge portion 12 and the bottom portion 11. The inclined portion 14 forms a portion that is inclined between edge portion 12 and bottom portion 11, thereby making the upper container 10 into a substantially box shape as shown in FIGS. 3 and 4.

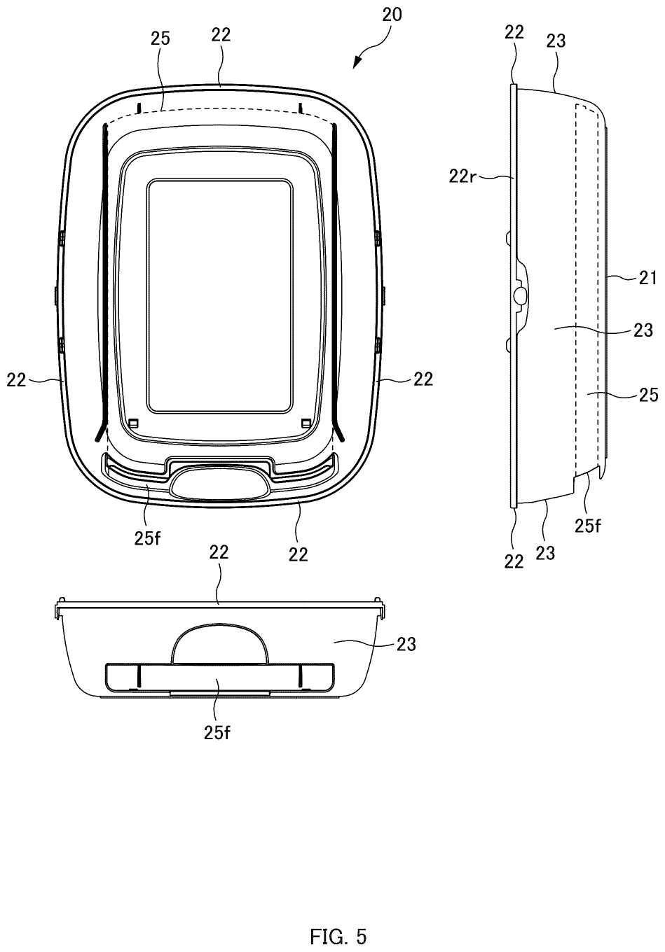

FIG. 5 is a three-side-view diagram of the lower container 20. The lower container 20 is a substantially box-shaped part having an open upper side, and is placed being stacked below and attached to the upper container 10, when the animal litter box 1 is used, as shown in FIGS. 1 and 2. The lower container 20 is a “supporting portion” that supports the upper container 10 and the tray 30. The lower container 20 includes a bottom portion 21, an edge portion 22, a side wall portion 23, and a tray housing portion 25. The bottom portion 21 is a portion that constitutes the bottom surface of the lower container 20. The edge portion 22 is a portion that constitutes the outer edge in the front-rear direction and the lateral direction, at the upper portion of the lower container 20. When the lower container 20 and the upper container 10 are attached to each other, the edge portion 12 of the upper container 10 and the edge portion 22 of the lower container 20 are stacked. The side wall portion 23 is a wall part standing upward from the end edge portion of the bottom portion 21.

The tray housing portion 25 is a portion that houses the tray 30. As shown in FIG. 5, an opening 25f is provided on the front side and below the edge portion 22. The tray 30 can be housed inside lower container 20 by slidingly moving the tray 30 from the opening 25f rearward in the front-rear direction along the tray housing portion 25, which is a portion surrounded by the dashed lines in FIG. 5.

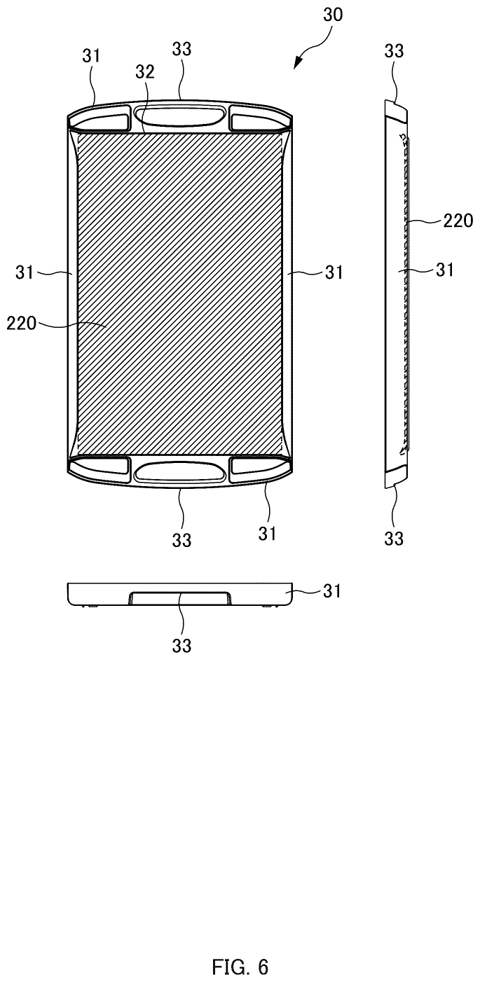

FIG. 6 is a three-side-view diagram of the tray 30. The tray 30 is a shallow and flat box-shaped container where an absorbent body for absorbing urine, and the like is placed. The tray 30 is also referred to as an “absorbent-body placement portion”. The tray 30 includes a side wall portion 31, an absorbent-body placement region 32, and a handle portions 33. The side wall portion 31 is a wall surrounding the outer periphery of the tray 30. In one or more embodiments, the tray 30 is formed in a rectangular shape symmetrical in the front-rear direction. Then, the absorbent-body placement region 32 in which the absorbent body is placed is formed in an inner region which is surrounded by the side wall portion 31.

FIG. 6 shows a state in which the absorbent body 220 (the hatched portion in the figure) is placed in the absorbent-body placement region 32. The Absorbent body 220 is a liquid-absorbent sheet that absorbs urine excreted by an animal such as a cat, and is formed by a liquid-absorbent material such as pulp fibers or a superabsorbent polymer. Further, deodorizing microcapsules and an antibacterial agent may be provided in the absorbent body 220 in order to trap the odor of absorbed urine and prevent the growth of bacteria. Although the absorbent body 220 is represented as a rectangular sheet in FIG. 6, there is no limitation on the shape of the absorbent body 220 as long as it can be held in the absorbent-body placement region 32.

The handle portions 33 are portions respectively formed in two end portions of the tray 30 in the front-rear direction. The tray 30 can be slid in the front-rear direction by holding and operating the handle portions 33 when the tray 30 is to be inserted into the lower container 20 or withdrawn from the lower container 20.

The cover 40 includes an entry/exit opening 41, a side wall portion 42, and an edge portion 43. The cover 40 is located above the upper container 10 and the lower container 20 (see FIG. 1). The entry/exit opening 41 is a wide opening forward in the front-rear direction, and an animal can enter and exit the animal litter box 1 from the entry/exit opening 41. In other words, the entry/exit opening 41 corresponds to the entrance/exit of the animal litter box 1. The side wall portion 42 is formed around the entry/exit opening 41. Providing the side wall portion 42 makes it possible to prevent the particulate absorbent body 220 and excrement from spilling or scattering outside the animal litter box 1 (upper container 10). Further, the edge portion 43 is a portion constituting the outer edge and located below the cover 40. By engaging the edge portion 43 with the edge portion 22 of the lower container 20, the cover 40 can be attached and fixed to the animal litter box 1.

When an animal such as a cat excretes, the animal enters the animal litter box 1 from the entry/exit opening 41 and excretes urine etc. in the bottom portion 11 where the granular excrement treating material 210 is placed, on the upper surface of the upper container 10. The excreted urine passes through the plurality of holes 101 of the bottom portion 11 and falls downward while being in contact with the excrement treating material 210. Then, the urine is absorbed by the absorbent body 220 arranged below the bottom portion 11 and is stored in the tray 30. The user can use the animal litter box 1 cleanly by periodically replacing the absorbent body 220 that has absorbed urine.

Note that the upper container 10, the lower container 20, the tray 30, and the cover 40 of the animal litter box 1 of one or more embodiments are each made of thermoplastic resin, and each has urinary contact portion(s) that has a possibility of coming into contact with urine. The “urinary contact portion” is a portion of a resin molding product that has a possibility of coming into contact with urine when the animal litter box 1 is used. Specifically, of each of the bottom portion 11, the stepped portion 13, and the inclined portion 14 of the upper container 10, the urinary contact portions of the upper container 10 are upper-surface-side (inside) portions and lower-surface-side (outside) portions, excluding the edge portion 12 in the portions that are in contact with the stacked lower container 20 and the portions that are in contact with the stacked cover 40. The urinary contact portions of the lower container 20 are upper-surface-side (inside) portions of the lower container 20, excluding the portions that are in contact with the stacked upper container 10. The urinary contact portions of the tray 30 re upper-surface-side (inside) portions. The urinary contact portions of the cover 40 are lower-surface-side (outside) portions of the cover 40, excluding the portions that are in contact with the upper container 10.

### Manufacturing of Resin Molding Product

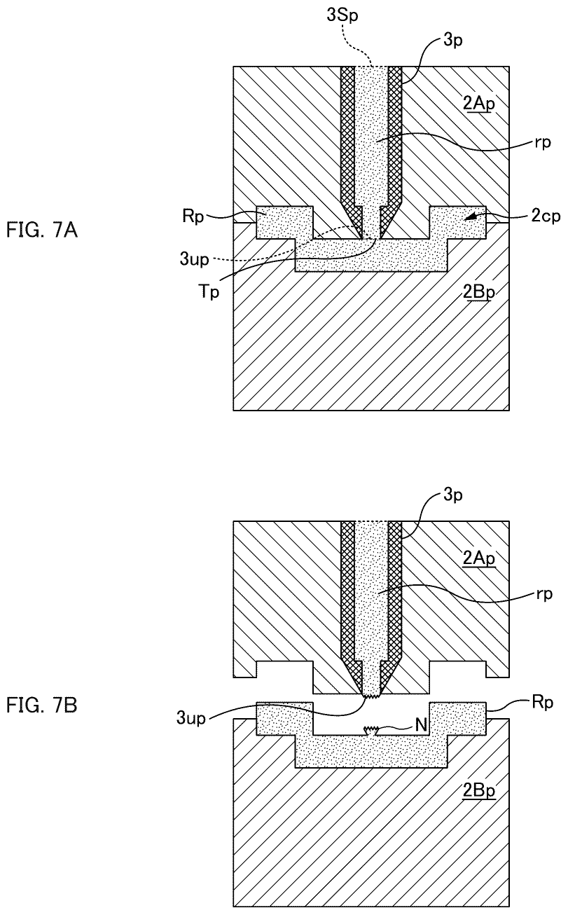

The resin molding product, which constitutes at least a part of the animal litter box 1, is a plastic product molded using injection molding molds. FIG. 7A is a diagram showing a conventional process of injecting resin into a mold, and FIG. 7B is a diagram showing a conventional process of separating a fixed mold and a resin molding product. As shown in FIG. 7A, resin rp is injected into the inside of a mold 2Cp from an injection hole 3p that is provided in an fixed mold 2Ap, and after the resin rp has been cured and the resin molding product Rp has been molded, the injection hole 3p is separated from the resin molding product Rp as shown in FIG. 7B. Conventionally, there is a risk that a projected/recessed portion N is formed in a portion Tp of the resin molding product Rp that faces the inner opening 3up of injection hole 3p. That this projected/recessed portion N is formed in the urinary contact portion of the resin molding product Rp causes a risk that urine excreted by an animal remains in recessed portions of the projected/recessed portion N and that the remaining urine generates a unpleasant odor.

On the other hand, in one or more embodiments, during the manufacturing process, a smoothing process of smoothing the urinary contact portion of the resin molding product is performed, reducing a risk that that a projected/recessed portion due to resin is formed in a portion of the resin molding product that faces the injection hole. This makes less likely to generate an unpleasant odor due to residual animal urine. In other words, at least a part of the animal litter box 1 which has the upper container 10 having a plurality of holes 101 and the tray 30 provided below the upper container 10 is a resin molding product which has a urinary contact portion. The resin molding products are manufactured as follow: preparing a mold which has an injection hole for injecting resin and which is for molding the resin molding product; injecting resin from the injection hole; and after the resin injection, smoothing the resin of a urinary contact portion, which located facing the inner opening of the injection hole. This reduces the risk that protrusions/recesses of resin are formed in the urinary contact portion of the animal litter box 1, and this makes it easier to reduce the odor of urine caused by urine collecting or remaining in protrusions/recesses of the resin molding product.

The resin molding product of animal litter box 1 is at least one of the upper container 10, the lower container 20, the tray 30, and the cover 40. It is possible to reduce the risk that protrusions/recesses of resin are formed in the urinary contact portion of at least one of these components, and this makes it easier to reduce the odor of urine caused by urine collecting or remaining in protrusions/recesses of the resin molding product. The following describes the manufacturing method of the upper container 10, employing the upper container 10 as an example of resin molding product made of a polyolefin-based thermoplastic resin.

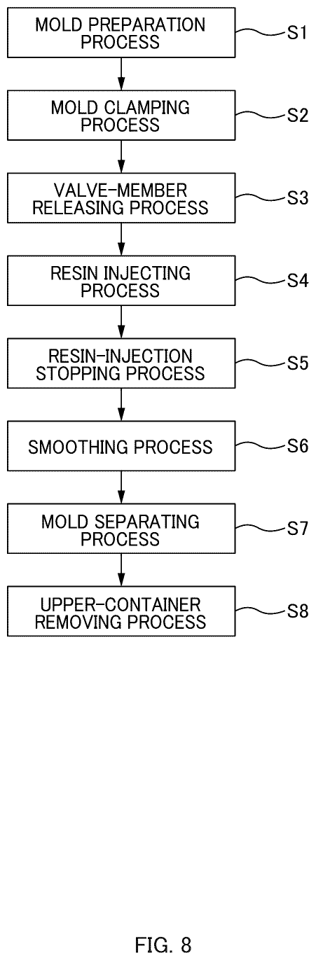

The upper container 10 is formed by injection molding, in which resin is injected and molded into a mold. As shown in FIG. 8, the upper container 10 is manufactured through the following processes: a mold preparation process (S1); a mold clamping process (S2); a valve-rod releasing process (S3); a resin injecting process (S4); a resin-injection stopping process (S5); a smoothing process (S6); a mold separating process (S7); and upper-container demolding process (S8). FIG. 8 is a flow chart of a manufacturing process of the upper container 10.

As described above, the upper container 10 has a plurality of holes 101 in the bottom portion 11, and accordingly the bottom portion 11 of the upper container 10 has a fine and complicated structure. In the injection molding of the upper container 10, which has this complicated structure, in order to spread the resin throughout the mold, resin r injected from an injection hole 3 would be injected from a position corresponding to the upper-surface side of the bottom portion 11. On the other hand, in the animal litter box 1, the upper container 10 passes the urine received from above through the holes 101 provided in the bottom portion 11 and moves it to the tray 30 below. Therefore, in the upper container 10, the upper surface of the bottom portion 11 is the urinary contact portion, which is especially the portion where urine tends to accumulate. Therefore, it is required to smooth the resin on the upper surface of the bottom portion 11 of the upper container 10 and reduce the unevenness. In one or more embodiments, there will be described a method of forming the upper container 10 by injection molding in which resin is injected from a position corresponding to the upper surface of the bottom portion 11 of the upper container 10.

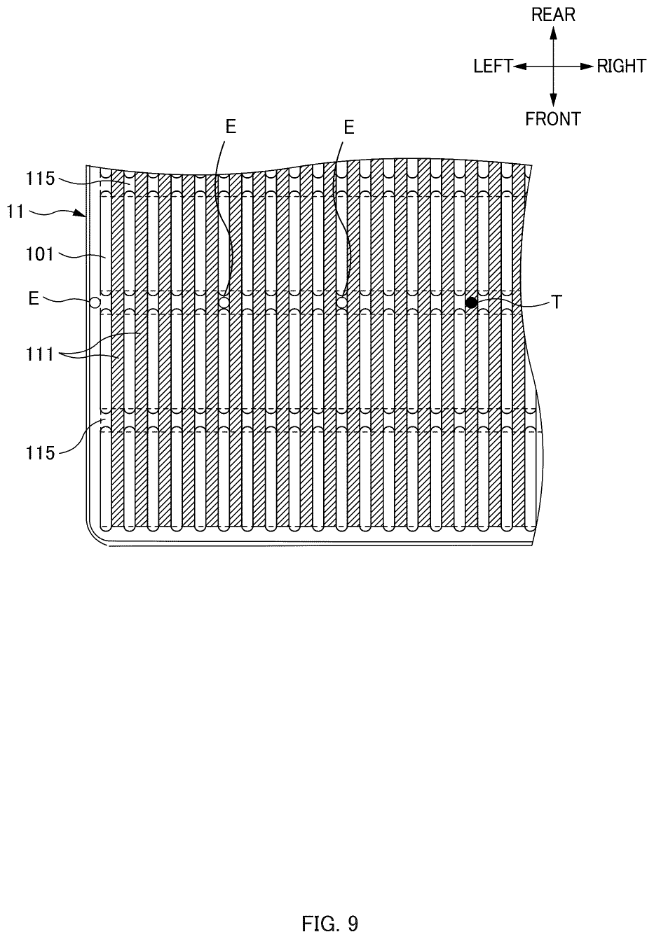

In the upper container 10 of one or more embodiments, the portion T of the upper surface T of the bottom portion 11 (FIGS. 3 and 9) is a portion that faces the inner opening 3u of the injection hole 3 when forming the upper container 10. Further, portions E shown in FIGS. 3 and 9 are portions that come into contact with ejector pins P in the later-described upper-container demolding process (S8). The portions E are provided on the lower-surface side in the upper container 10, but for the sake of convenience, the portions E are indicated in solid lines in FIGS. 3 and 9.

FIG. 9 is an enlarged view of a portion D in FIG. 3, and is an enlarged view of a part of the bottom portion 11. The plurality of holes 101 of the bottom portion 11 are formed by being surrounded by longitudinal ribs 111 arranged along the front-rear direction and lateral ribs 115 arranged along the lateral direction. The plurality of holes 101 formed in this manner are regularly arranged in the front-rear direction and the lateral direction. Note that, for the sake of convenience, in FIG. 9, the longitudinal ribs 111 are shown being hatched. As shown in FIG. 9, the portion T may be provided at a portion where a longitudinal rib 111 and a lateral rib 115 intersect, that is, a portion that is located on the longitudinal rib 111 and simultaneously is located on the lateral rib 115. Compared to the case where the portion T is provided in a portion where only longitudinal rib 111 exists or a portion where only lateral rib 115 exists, it makes it easier to spread the resin r throughout the mold, and to inject the resin r in a stable state.

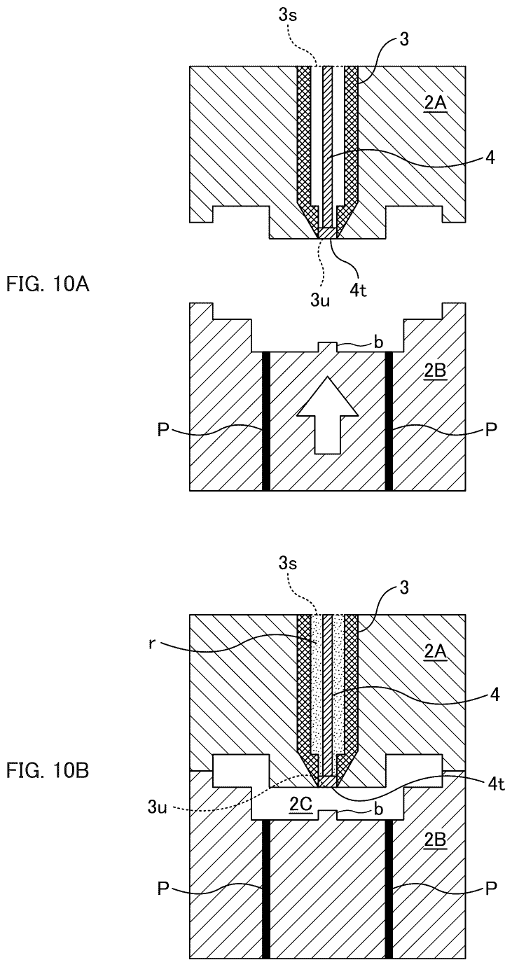

The following describes the steps of forming upper container 10 with reference to FIGS. 10A to 13B. FIGS. 10A to 13B are schematic diagrams for explaining the molding of the upper container 10, and dimensions etc. are not necessarily accurate.

First, the mold preparation process in which a mold is prepared (S1) is performed. FIG. 10A is a diagram illustrating the mold preparation process (S1). The mold is a metal mold for molding the molding material into a certain shape, and is constituted by a fixed mold 2A and a movable mold 2B. In addition, a set of the fixed mold 2A and the movable mold 2B is referred to as a “mold”, and in the mold clamping process (S2), between the later-described fixed mold 2A and movable mold 2B, a cavity 2C (also referred to as “mold 2C”) is formed. The fixed mold 2A side is defined as the “upper side” and the movable mold 2B side is defined as the “lower side”. Further, the fixed mold 2A molds at least the upper end of the upper container 10, and the movable mold 2B molds at least the lower end of the upper container 10.

The fixed mold 2A is of a mold that does not perform opening/closing movements and has injection holes 3. Each of the injection holes 3 is for injecting resin r, and has a cylindrical shape with a hollow inside. In the injection holes 3, resin r is injected from the outer openings 3s into the cavity 2C through the inner openings 3u. The outer openings 3s are inlets for injecting resin r into the injection holes 3. The inner openings 3u are outlets for injecting resin r from the injection holes 3 into the cavity 2C, and are portions that face the corresponding portions T after the resin injecting process. Further, the fixed mold 2A includes valve rods 4. Each valve rod 4 has a substantially cylindrical shape, and its tip surface 4t on the inner opening 3u side of the injection hole 3 (lower side) has a flat surface. The valve rod 4 can move with respect to the injection hole 3 by receiving driving power from a drive source. Specifically, the valve rod 4 can move in the vertical direction along the hollow within injection hole 3. The movable mold 2B is of a mold that performs opening/closing movements, and has the ejector pins P. The injection holes 3, the valve rods 4, and the ejector pins P may be each made of metal. Further, the arrangement, number, shape, and size of the injection holes 3 and ejector pins P may be changed depending on the shape and size of the resin molding product.

Next, the mold clamping process (S2) is performed. FIG. 10B is a diagram illustrating the mold clamping process. The mold clamping process (S2) is a process of clamping the mold; in the process, the cavity 2C is made be a closed space by moving the movable mold 2B with respect to the fixed mold 2A. In the mold clamping process, it is possible to use a well-known mold clamping device, and, for example, an electric device, a hydraulic device, or the like can be used as a mold clamping device.

In the state of the mold clamping process (S2), as shown in FIG. 10B, fluid resin r may be stored in the hollow part of the injection hole 3. For example, when forming the upper container 10 in succession, by storing resin r in the hollow part of the injection hole 3 during the mold preparation process (S1) and the mold clamping process (S2), it is possible to efficiently form the upper container 10. Note that FIG. 10A shows a state in which resin r is not contained in the injection hole 3. In the mold clamping process (S2) of one or more embodiments, the tip surface 4t of the valve rod 4 is aligned with the edge of the inner opening 3u of the injection hole 3, and the inner opening 3u of the injection hole 3 is blocked by the tip surface 4t of the valve rod 4. Accordingly, at this stage, the resin r remains within the injection hole 3. The resin r in the injection hole 3 is made into a fluid (like starch syrup) by heating and melting a pellet-shaped plastic material which is stored in a hopper (not shown) provided outside the injection hole 3. Further, the injection hole 3 is provided with a heater (not shown) in order to maintain the fluid resin r and pour it into the cavity 2C.

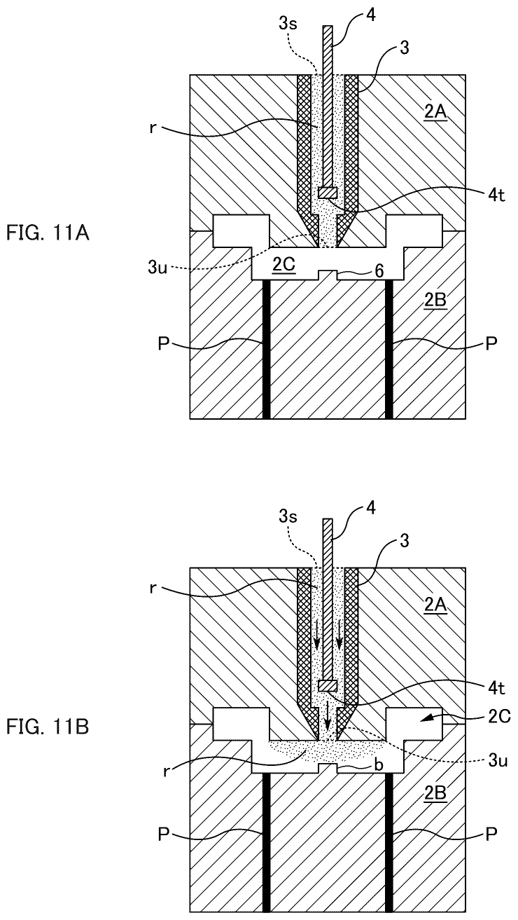

Then, the valve-rod releasing process (S3) is performed. FIG. 11A is a diagram illustrating the valve-rod releasing process. In the valve-rod releasing process (S3), the valve rod 4 is made into a state where the tip surface 4t of the valve rod 4 is located closer to the outer opening 3s than the inner opening 3u by moving it to the outer opening 3s side of the injection hole 3. In other words, the tip surface 4t of the valve rod 4, which is blocking the inner opening 3u of the injection hole 3, is separated away from the inner opening 3u. As a result, the inner opening 3u of the injection hole 3 is opened, making it possible to inject resin r. The valve rod 4 may be moved by receiving driving power from the drive source using electric power, or may be moved by receiving driving power from the drive source using hydraulic power.

After that, the resin injecting process (S4) is performed. FIG. 11B is a diagram illustrating the resin injecting process. In the resin injecting process (S4), the resin r in the injection hole 3 is poured into the cavity (mold) 2C through the inner opening 3u of the injection hole 3. In the resin injecting process (S4), the resin r is injected by applying pressure from the injection hole 3 toward the cavity 2C. In the resin injecting process (S4) of one or more embodiments, the resin r is injected into the cavity 2C while the tip surface 4t of the valve rod 4 is located closer to the outer opening 3s than the inner opening 3u. In addition, in the resin injecting process (S4), the resin-injection stopping process (S5), and the smoothing process (S6), processings of the processes may be performed while applying a predetermined pressure to the inside of the mold (inside the cavity 2C).

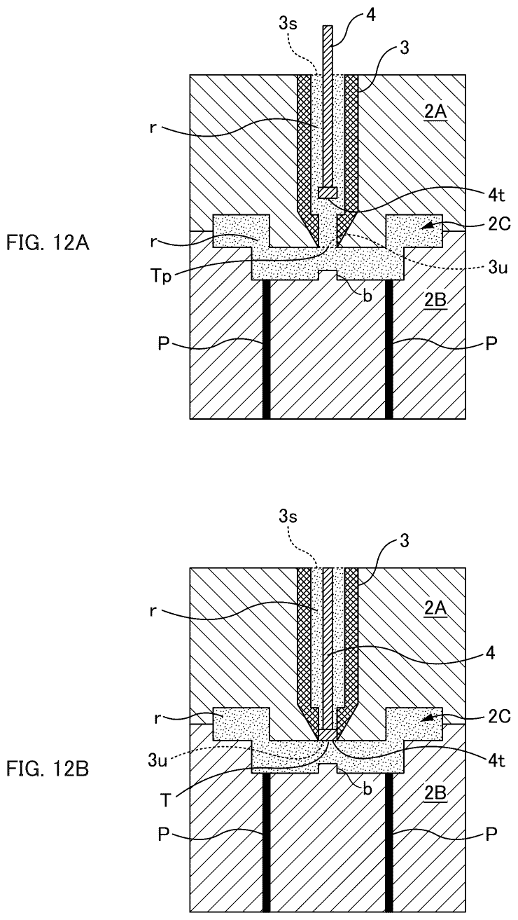

When a predetermined amount of resin r is injected into the cavity 2C and the resin r is spread throughout the mold 2C without any gaps, the resin-injection stopping process (S5) is performed to stop injecting the resin r. FIG. 12A is a diagram illustrating the resin-injection stopping process. Specifically, the pressure applied to the resin r from injection hole 3 toward cavity 2C is stopped.

Next, the smoothing process (S6) is performed. FIG. 12B is a diagram illustrating the smoothing process. In one or more embodiments, the smoothing process (S6) is performed after the resin-injection stopping process (S5) and before the resin r has been hardened. In the smoothing process (S6), the valve rod 4 is moved downward (to the inner opening 3u side) and blocks the inner opening 3u of the injection hole 3, and the tip surface 4t of the valve rod 4 is made aligned with the edge of the inner opening 3u. Until the resin r solidifies and the upper container 10 is molded, it maintains the state where the tip surface 4t of the valve rod 4, which is aligned with the edge of the inner opening 3u, blocks the inner opening 3u. As a result, the portion T of the upper container 10 that faces the inner opening 3u of the injection hole 3 is solidified being leveled by a flat portion of the tip surface 4t of the valve rod 4. This makes it possible to reduce a risk that projected/recessed portions (see FIG. 7B) are formed in portion T of the upper container 10 that faces the inner opening 3u of the injection hole 3. Further, by performing the smoothing process (S6) within the mold after resin injecting process (S4) and before the upper-container demolding process (S8), it becomes easier to simplify the manufacturing process for the upper container 10.

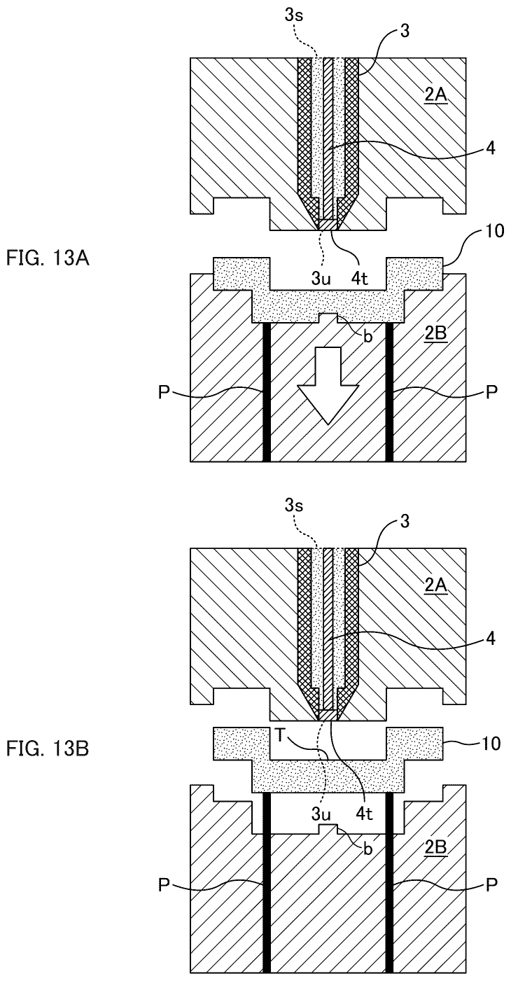

After the smoothing process (S6), when the resin r has been solidified and the upper container 10 has been molded, the mold separating process (S7) is performed. FIG. 13A is a diagram illustrating the mold separating process. The mold separating process (S7) is a process of opening the mold. The movable mold 2B is moved with respect to the fixed mold 2A to release the closed space of the cavity 2C. The mold separating process (S7) can be performed by the mold clamping device for the above-mentioned mold clamping process (S2). As shown in FIG. 13A, the upper surface side of the upper container 10 and the fixed mold 2A are separated in the mold separating process (S7).

Finally, the upper-container demolding process (S8) is performed. FIG. 13B is a diagram illustrating the upper-container demolding process. The upper-container demolding process (S8) is a process of demolding the molded upper container 10 from the mold. In one or more embodiments, the upper-container demolding process (S8) is a process of separating the movable mold 2B and the upper container 10. As shown in FIG. 13B, in one or more embodiments, it is possible to take out the molded upper container 10 from the movable mold 2B by pushing the upper container 10 upward from the lower surface side of the upper container 10 using the ejector pins P provided in the movable mold 2B.

As in one or more embodiments, in the case where resin is injected from the upper surface side of the upper container 10 through the injection holes 3 and the upper container 10 is taken out from the lower surface side of the upper container 10 using the ejector pins P, the number of the injection holes 3 may be smaller than the number of the ejector pins P. In the upper container 10, urine received from above transfers to the tray 30 provided below by passing through the holes 101 provided in the bottom portion 11 of the upper container 10, and therefore the urine is likely to be accumulated in the projected/recessed portions on the upper surface side of the upper container 10. Therefore, even if the upper container 10, which is a resin molding product, is made of a relatively soft material and there is a risk that marks such as projected/recessed portions may remain on the portions E (FIGS. 3 and 9) due to contact with the ejector pins P even after molding, it is possible to reduce the number of projected/recessed portions that are produced in the portions that respectively face the inner openings 3u of the injection holes 3 and that are formed on the upper surface of the upper container 10 compared to the number of projected/recessed portions that are produced in the portions that respectively come into contact with the ejector pins and that are P formed on the lower surface of the upper container 10. This makes it possible to reduce the risk of unpleasant odors caused by urine accumulating in the projected/recessed portions on the upper surface of the upper container 10.

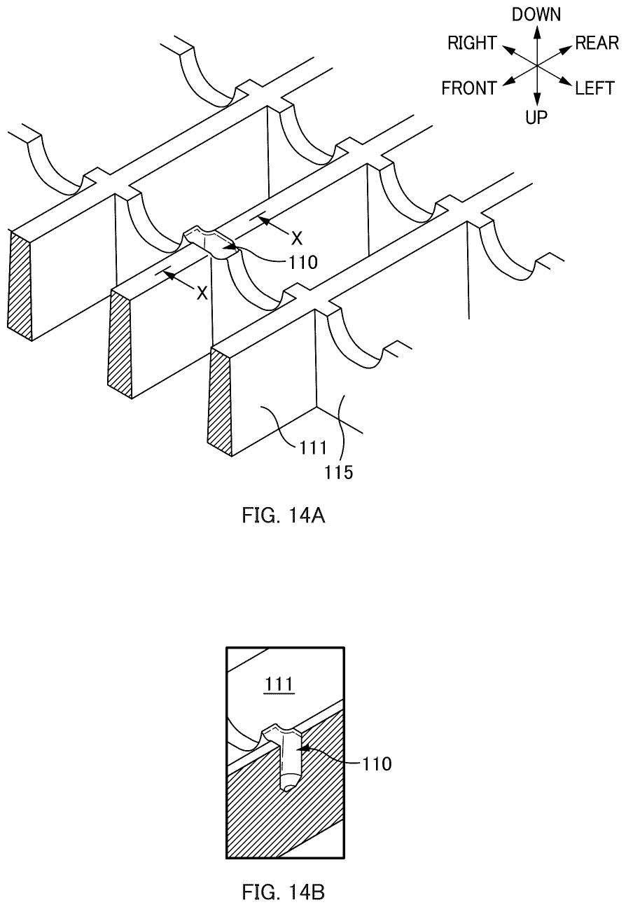

Moreover, the mold may have a protruding portion b which protrudes toward the inner opening 3u, in a portion that faces the inner opening 3u. In the resin injecting process (S4), if inflow pressure of the resin r to be injected creates air pockets in the portion that faces the injection hole 3, there is a risk that the resin r is not injected into the air pockets. In this regard, in one or more embodiments, the movable mold 2B has a protruding portion b in the portion that faces the inner opening 3u, with respect to the injection hole 3 located on the fixed mold 2A side, as shown in FIGS. 10A to 13B. By providing the protruding portion b which protrudes toward the inner opening 3u, it is possible to reduce a risk that, in the resin injecting process (S4), the inflow pressure of the resin r to be injected creates air pockets in the portion that faces the injection hole 3. This makes it easier to spread the resin r throughout the cavity 2C, reducing a risk of partially chipping the shape of the upper container 10. This makes it easier to mold the upper container 10 into a desired shape. Note that, due to the protruding portion b of the movable mold 2B, a recessed portion 110 is formed on the lower surface of the bottom portion 11 of the upper container 10 that has been molded, as shown in FIGS. 14A and 14B. FIG. 14A is a schematic perspective view of the bottom portion 11 when viewed from the lower surface side. FIG. 14B is a diagram illustrating a cross section taken along line X-X in FIG. 14A.

In the above-described embodiments, the valve rod 4 is used which moves by receiving driving power from drive source, but the present invention is not limited thereto. For example, the valve rod (not shown) which is supported by a spring and can move relative to the injection hole 3 may be used. In that case, the following method may be employed: in the resin injecting process (S4), the resin r is injected in a state where the inflow pressure of the resin r makes the tip surface 4t of the valve rod 4 protrude from the inner opening 3u into the cavity 2C (inside the mold), and in the subsequent smoothing process (S6), the inner opening 3u is blocked by the valve rod 4 (tip surface 4t) using the restoring force of the spring, and the resin r is smoothed by aligning the tip surface 4t with the edge of the inner opening 3u. Even in the case of using such valve rod 4, performing the smoothing process (S6) within the mold makes it easier to simplify the manufacturing process of the upper container 10. In addition, the smoothed upper container 10 can reduce a risk of an unpleasant odor caused by urine accumulating in the projected/recessed portions.

Also, as another modified example using the valve rod 4 which is supported by a spring and can move relative to the injection hole 3, the following method may be employed: in the resin injecting process (S4), the resin r is injected in a state where the inflow pressure of the resin r makes the tip surface 4t of the valve rod 4 be located closer to the outer opening 3s than to the inner opening 3u, and in the subsequent smoothing process (S6), the inner opening 3u is blocked by the valve rod 4 (tip surface 4t) using the restoring force of the spring, and the resin r is smoothed by aligning the tip surface 4t with the edge of the inner opening 3u. Even in the case of using such valve rod 4, performing the smoothing process (S6) within the mold makes it easier to simplify the manufacturing process of the upper container 10. In addition, the smoothed upper container 10 can reduce a risk of an unpleasant odor caused by urine accumulating in the projected/recessed portions.

Further, in the above embodiments, the fixed mold 2A molds at least the upper end of the upper container 10, the movable mold 2B molds at least the lower end of the upper container 10, the injection holes 3 are provided in the fixed mold 2A side, and the movable mold 2B has the ejector pins P. However, the injection holes 3 and the ejector pins P may be provided on the fixed mold 2A side. Even in such a case, by smoothing the resin r of the portions that face the injection holes 3 of the inner openings 3u, it makes it possible to reduce the risk of producing protrusions/recesses in the portion T, causing unpleasant odors due to accumulation of urine there.

In the above-described embodiments, the resin on the upper-surface side of the upper container 10 is smoothed, but the present invention is not limited to this. The following method may be employed: the resin r is injected from a position corresponding to the lower-surface side of the upper container 10, and the resin in a portion of the upper container 10 on the lower-surface side that faces the inner opening 3u of the injection hole 3 is smoothed. By smoothing the resin on the lower surface of the upper container 10 and thereby reducing the unevenness on the lower surface, it allows urine passing through the hole 101 of the upper container 10 to remain on the unevenness of the lower surface. If the urine passing through the hole 101 of the upper container 10 remains on the lower surface, the water in the urine evaporates, and thereby the concentration of the urine increases, making unpleasant odors likely to occur. Therefore, by reducing the unevenness on the lower surface of the upper container 10 and thereby reducing the amount of urine remaining on the lower surface, it is possible to reduce the risk of unpleasant odors. Note that as a method for smoothing the resin on the lower-surface side of the upper container 10, it is possible to use a method for smoothing the resin on the upper-surface side of the upper container 10.

Further, a configuration may be acceptable in which the fixed mold 2A on the side where the injection holes 3 are provided molds at least the lower end of the upper container 10, and in which the movable mold 2B including the ejector pins P molds at least the upper end of the upper container 10. In such a case, the number of injection holes 3 that faces the position corresponding to the lower surface of the upper container 10 may be smaller than the number of ejector pins P that come into contact with the upper surface of the upper container 10. The number of projected/recessed portions that has been produced in portions facing the inner openings 3u of injection holes 3 formed on the lower surface of the upper container 10 can be made smaller than the number of projected/recessed portions that has been produced in the portions that come into contact with the ejector pins P formed on the upper surface of the upper container 10. This reduces the amount of urine remaining in the projected/recessed portions on the lower surface of the upper container 10, making it possible to reduce a risk of unpleasant odors.

Furthermore, in the case where the fixed mold 2A molds at least the lower end of the upper container 10 and the movable mold 2B molds at least the upper end of the upper container 10, the injection holes 3 and the ejector pins P may be provided on the fixed mold 2A side. Even in such a case, by smoothing the resin r on the portions that face the injection holes 3 of the inner openings 3u, it makes it possible to reduce a risk of producing protrusions/recesses in the portions that face the injection holes 3 of the inner openings 3u, causing unpleasant odors due to accumulation of urine there.

In the above-described embodiments, the smoothing process (S6) is performed after the resin injecting process (S4) and before the upper-container demolding process (S8), but the present invention is not limited to this. The smoothing process can be performed at any timing. For example, instead of performing the smoothing process after the resin injecting process (S4) and before the upper-container demolding process (S8), the smoothing process may be performed after the upper-container demolding process (S8). After the upper-container demolding process (S8), it is possible to smooth the resin while being capable of seeing projected/recessed portions of the upper container 10, making it possible to reliably make a smooth surface.

In the smoothing process which is performed after the upper-container demolding process (S8), it is possible to remove protrusions that protrude from the surface of the upper container 10 or to fill recessed portions of the surface of the upper container 10. As a method for removing the protrusions that protrude from the surface of the upper container 10, it is possible to employ physical removal methods such as cutting, polishing, and fusing. As a method for filling the recessed portions of the surface of the upper container 10, it is possible to employ filling of the recessed portions with another member such as a resin. By using such methods, it is possible to easily reduce projected/recessed portions of the surface of the upper container 10. Furthermore, the following method may be employed: the smoothing process (S6) is performed after the resin injecting process (S4) and before the upper-container demolding process (S8), and the smoothing process is further performed after the upper-container demolding process (S8). It is possible to more reliably reduce projected/recessed portions of the surface of the upper container 10.

### Other Embodiments

Although the embodiments of the present disclosure have been described hereinabove, the above embodiments of the present disclosure are simply to facilitate understanding of the present disclosure and is not in any way to be construed as limiting the present disclosure. Further, it goes without saying that the present disclosure may variously be changed or altered without departing from its gist and encompass equivalents thereof. For example, the following modifications are possible.

In the above-described embodiments, the manufacturing method of the upper container 10 is described as the manufacturing method of the resin molding product, but the present invention is not limited to this. Of the animal litter box 1, the manufacturing method of one or more embodiments of the present invention is applicable to the manufacturing of a resin molding product which has the urinary contact portion. For example, it may be used for manufacturing the lower container 20, the tray 30, or the cover 40, which include a urinary contact portion. In addition, in one or more embodiments, the entirety of the upper container 10 is a resin molding product. But the present invention is not limited thereto, and the manufacturing method may be for a resin molding product in which a part of the upper container 10, the lower container 20, the tray 30, or the cover 40 includes a urinary contact portion.

In the above-described embodiments, as shown in FIG. 1, the animal litter box 1 includes the cover 40. But, the present invention is not limited thereto, and the cover 40 does not have to be included. Further, in the animal litter box 1, the lower container 20 supports the upper container 10 and the tray 30. But, the present invention is not limited thereto, and the lower container 20 does not have to be included. It is sufficient that the animal litter box includes at least the upper container 10 and the tray 30.

In the above-described embodiments, excrement treating materials 210, which are granules such as cat litter, etc., are placed in the bottom portion 11 of the upper container 10. But, the present invention is not limited thereto, and other granules may be placed. Further, granules does not have to be placed.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

### REFERENCE SIGNS LIST

1. animal litter box,
10. upper container (urine passage portion),
11. bottom portion,
12. edge portion,
13. stepped portion,
14. inclined portion,
20. lower container (supporting portion),
21. bottom portion,
22. edge portion,
23. side wall portion,
25. tray housing portion,
25f opening,
30. tray (absorbent-body placement portion),
31. side wall portion,
32. absorbent-body placement region,
33. handle portion,
40. cover,
41. entry/exit opening,
42. side wall portion,
43. edge portion,
101. hole (slit),
110. recessed portion,
111. longitudinal rib,
115. lateral rib,
210. excrement treating material,
220. absorbent body,
2A fixed mold,
2B movable mold,
2C cavity (mold),
3. injection hole,
3s outer opening,
3u inner opening,
4. valve rod,
4t tip surface,
P ejector pin,
T portion (urinary contact portion that faces the inner opening 3u of the injection hole 3)

What is claimed is:

1. A manufacturing method of an animal litter box, comprising:
a mold preparation process of preparing a mold for molding a resin molding product that forms at least a part of the animal litter box and has a urinary contact portion, wherein the mold has an injection hole for injecting resin;
a resin injecting process of injecting the resin from the injection hole; and
a smoothing process of smoothing the resin of the urinary contact portion, the resin facing an inner opening of the injection hole, after the resin injecting process.

2. The manufacturing method according to claim 1, wherein
the resin molding product is at least one of:
a urine passage portion that has urine passing holes;
an absorbent-body placement portion that is disposed below the urine passage portion and in which an absorbent body is placed, the absorbent body absorbing urine that has passed through the urine passage portion;
a supporting portion that supports the absorbent-body placement portion; and
a cover that is disposed above the urine passage portion.

3. The manufacturing method according to claim 1, further comprising:
a demolding process of demolding the resin molding product that has been molded from the mold after the resin injecting process, wherein
the smoothing process is performed after the demolding process.

4. The manufacturing method according to claim 3, wherein
the smoothing process includes removing a projection of the resin molding product that protrudes from a surface of the resin molding product.

5. The manufacturing method according to claim 3, wherein
the smoothing process includes filling a recessed portion of a surface of the resin molding product.

6. The manufacturing method according to claim 1, further comprising:
a demolding process of demolding the resin molding product that has been molded from the mold, wherein
the demolding process is performed after the smoothing process.

7. The manufacturing method according to claim 6, further comprising:
preparing a valve rod that moves with respect to the injection hole by receiving a driving power from a drive source, wherein
the resin injecting process includes:
injecting the resin in a state where a tip surface of the valve rod is located closer to an outer opening than is the inner opening, and
the smoothing process includes:
smoothing the resin by closing the inner opening with the valve rod and by aligning the tip surface with an edge of the inner opening.

8. The manufacturing method according to claim 6, further comprising:
preparing a valve rod supported by a spring and movable with respect to the injection hole, wherein
the resin injecting process includes:
injecting the resin in a state where a tip surface of the valve rod protrude from the inner opening into the mold by an inflow pressure of the resin, and
the smoothing process includes:
closing the inner opening with the valve rod by a restoring force of the spring, and
smoothing the resin by aligning the tip surface with an edge of the inner opening.

9. The manufacturing method according to claim 6, further comprising:
preparing a valve rod supported by a spring and movable with respect to the injection hole, wherein
the resin injecting process includes:
injecting the resin in a state where a tip surface of the valve rod is located closer to an outer opening than is the inner opening by an inflow pressure of the resin,
the smoothing process includes:
closing the inner opening with the valve rod by a restoring force of the spring, and
smoothing the resin by aligning the tip surface with an edge of the inner opening.

10. The manufacturing method according to claim 1, wherein
the mold has a protruding portion that faces the inner opening and protrudes toward the inner opening.

11. The manufacturing method according to claim 1, wherein
the resin molding product is a urine passage portion that has urine passing holes, and
the smoothing process includes smoothing the resin on an upper surface of the urine passage portion.

12. The manufacturing method according to claim 11, wherein
the mold includes:
a fixed mold for molding at least an upper end of the urine passage portion, and
a movable mold for molding at least a lower end of the urine passage portion,
the fixed mold includes the injection hole,
the movable mold includes an ejector pin for separating the urine passage portion from the movable mold in a demolding process of demolding the urine passage portion that has been molded from the mold after the resin injecting process, and
a number of the injection hole is smaller than a number of the ejector pin.

13. The manufacturing method according to claim 11, wherein
the mold includes:
a fixed mold for molding at least an upper end of the urine passage portion, and
a movable mold for molding at least a lower end of the urine passage portion,
the fixed mold includes:
the injection hole; and
an ejector pin for separating the urine passage portion from the movable mold in a demolding process of demolding the urine passage portion that has been molded from the mold after the resin injecting process.

14. The manufacturing method according to claim 1, wherein
the resin molding product is a urine passage portion that has urine passing holes, and
the smoothing process includes smoothing the resin on a lower surface of the urine passage portion.

15. The manufacturing method according to claim 14, wherein
the mold includes:
a fixed mold for molding at least a lower end of the urine passage portion, and
a movable mold for molding at least an upper end of the urine passage portion,
the fixed mold includes the injection hole,
the movable mold includes an ejector pin for separating the urine passage portion from the movable mold in a demolding process of demolding the urine passage portion that has been molded from the mold after the resin injecting process, and
a number of the injection hole is smaller than a number of the ejector pin.

16. The manufacturing method according to claim 14,
the mold includes:
a fixed mold for molding at least a lower end of the urine passage portion, and
a movable mold for molding at least an upper end of the urine passage portion,
the fixed mold includes:
the injection hole; and
an ejector pin for separating the urine passage portion from the movable mold in a demolding process of demolding the urine passage portion that has been molded from the mold after the resin injecting process.

17. An animal litter box comprising:
a urine passage portion that has a plurality of urine passing holes; and
an absorbent-body placement portion that is disposed below the urine passage portion and in which an absorbent body is placed, the absorbent body absorbing urine that has passed through the urine passage portion, wherein
at least a part of the animal litter box is a resin molding product molded with a mold, the mold having an injection hole for injecting resin,
the resin molding product has a urinary contact portion,
the animal litter box is manufactured by injecting the resin from the injection hole and by smoothing the resin of the urinary contact portion, the resin facing an inner opening of the injection hole, after injecting the resin.
